(19) United States
(12) Patent Application Publication
(10) Pub. No.: US 2004/0031399 A1
(43) Pub. Date: Feb. 19, 2004

(54) Food preparation station

(76) Inventor: Michael J. Christy, Carrollton, TX (US)

Correspondence Address: Michael L. Diaz, Michael L. Diaz, P.C., 555 Republic Drive, Suite 200, Plano, TX, 75074, US

(21) Appl. No.: 10/218,839

(22) Filed: Aug. 14, 2002

(51) Int. Cl. A23L 1/00

(52) U.S. Cl. 99/485

(57) ABSTRACT

A food preparation station for use on top of a counter. The food preparation station includes a flat work area. On a front edge of the work area is an anchoring ledge. On an opposite rear portion of the work area is a retaining device for holding a cooking utensil, such as a rolling pin. The work area includes a nonskid material affixed to a bottom surface of the work area for preventing slippage of the food preparation station on top of the counter. The preparation station is positioned on top of the counter with the rear portion of the work area abutting a rear wall lying perpendicular to the counter. The preparation station is anchored to the counter by the anchoring ledge being positioned against a front counter edge. The preparation station is preferably constructed of stainless steel.

### BACKGROUND OF THE INVENTION

1. Technical Field of the Invention

This invention relates to kitchen accessories, and more particularly, to a mobile food preparation station for use within a kitchen.

2. Description of Related Art

A place to prepare various food items for consumption is an important part of any home. Typically, within a kitchen, there are various counter spaces for the placement and preparation of food. One of the more common tasks accomplished during food preparation involves cutting food with sharp knives. However, it is undesirable to cut the food on a bare counter. The counters are usually made of a material which are not resistant to scratches from knifes, which cut through the food and contact the counter tops. A cutting board is often used to protect the counter tops from damage caused by utilizing knifes during the preparation of food. The food is placed on the cutting board and the knife is then cut through the food. The knife may contact the cutting board, which gouges the cutting board, rather than the counter top. Typically, the cutting board is constructed of a plastic or wood which protects the counter top at the expense of the cutting board.

Although the cutting boards provide protection for the counter tops, the boards have several disadvantages. The cutting board are breeding ground for various forms of bacteria. The gouges on the upper surface of the cutting board make it extremely difficult to effectively clean and remove the bacteria.

In addition, the cutting boards are not conducive for various cooking duties. For example, when rolling dough on a cutting board, the dough often sticks to the cutting board, due to the composition of the cutting board and the lack of a smooth surface. In addition, cutting boards do not provide a firm foundation for cutting items on the cutting boards. The cutting boards often move along the counter. In addition, the cutting boards do not provide a retaining device for holding cooking utensils close to the preparation area.

Existing devices reveal no disclosure or suggestion of a food preparation station providing a sanitary and stable work station as that described and claimed herein. Thus, it would be a distinct advantage to have a moveable work station having a sanitary surface and a retaining device for holding a cooking utensil. It is an object of the present invention to provide such a device.

### SUMMARY OF THE INVENTION

In one aspect, the present invention is a food preparation station for use on a counter top. The food preparation station includes a flat work surface having a front edge and a back edge. The front edge has an anchoring ledge laying against a front counter edge of the counter top. The back edge is abutted against a back wall running perpendicular to the counter top. A nonskid material is affixed to a bottom surface of the flat work surface and a top surface of the counter top for preventing slippage of the food preparation station on the counter top. The food preparation station is laid on the counter top and is positioned against the back wall and anchored along the anchoring ledge.

In another aspect, the present invention is a food preparation system. The system includes a counter adjacent a back wall. The counter has a front counter edge. In addition, the system includes a food preparation station having a planar work area with a front portion and a rear portion. The front portion has an anchoring ledge laying against the front counter edge. The back portion is abutted against the back wall. A nonskid material is positioned between a bottom surface of the planar work area and a top surface of the counter for preventing slippage of the food preparation station on the counter. The food preparation station is laid on the counter and is positioned against the back wall and anchored along the anchoring ledge.

In still another aspect, the present invention is a food preparation station for use on a counter top. The food preparation station includes a flat work surface having a front edge and a back edge. The front edge has an anchoring ledge laying against a front counter edge of the counter top. The back edge is abutted against a back wall running perpendicular to the counter top. A nonskid material is positioned between a bottom surface of the flat work surface and a top surface of the counter top for preventing slippage of the food preparation station on the counter top. A cooking utensil is retained on the food preparation station. The station may be constructed of stainless steel.

### BRIEF DESCRIPTION OF THE DRAWINGS

The invention will be better understood and its numerous objects and advantages will become more apparent to those skilled in the art by reference to the following drawings, in conjunction with the accompanying specification, in which:

FIG. 1 is top plan view of a food preparation station having a utensil retaining area and an anchoring ledge in the preferred embodiment of the present invention;

FIG. 2 is a side partial cross sectional view of the food preparation station of FIG. 1 positioned on a kitchen counter top in the preferred embodiment of the present invention;

FIG. 3 is an enlarged partial side view of the utensil retaining area in the preferred embodiment of the present invention;

FIG. 4 is a bottom view of the food preparation station in a first alternate embodiment of the present invention;

FIG. 5 is a top plan view of the food preparation station in a second alternate embodiment of the present invention; and

FIG. 6 is an enlarged partial side view of the retaining area of FIG. 5.

### DETAILED DESCRIPTION OF EMBODIMENTS

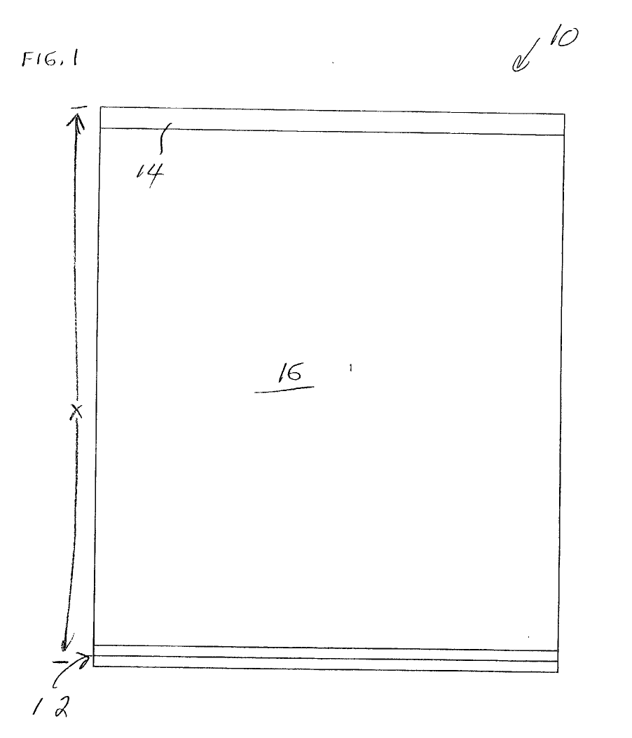

A moveable food preparation station having a sanitary and smooth surface is disclosed. FIG. 1 is top plan view of a food preparation station 10 having a utensil retaining area 12 and an anchoring ledge 14 in the preferred embodiment of the present invention. The food preparation station is preferably constructed of a stainless steel material. However, any rigid material may be used in the construction of the food preparation station. The main body of the food preparation station is a flat work area 16.

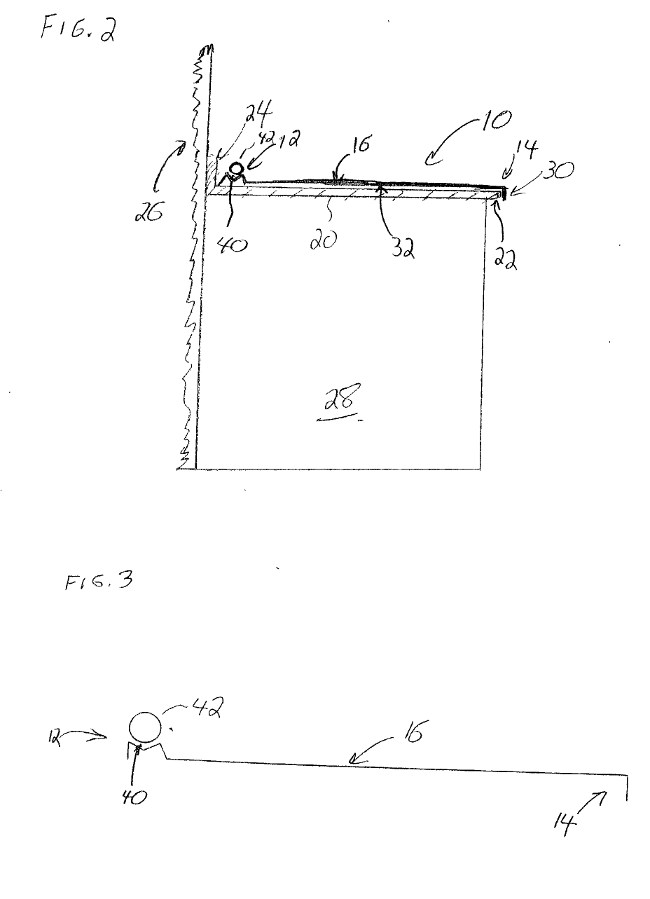

FIG. 2 is a side partial cross sectional view of the food preparation station 10 of FIG. 1 positioned on a kitchen counter top 20 in the preferred embodiment of the present invention. A primary portion of the food preparation station is the work area 16 providing a large working area for an operator to utilize the food preparation station. The food preparation area preferably has a length X running the depth of the counter top from an edge 22 to a back splash 24 running on a portion of a back wall 26. Typically, the length X is approximately 23 inches. The food preparation station abuts against the back splash 24 on top of the counter top, which rest upon a cabinet 28. The anchoring ledge includes a perpendicular downward bend providing a lip 30 over the edge 22 of the counter top.

To prevent skidding upon the counter top 20, a nonskid material 34 is preferably affixed to a bottom surface 32 of the food preparation station. The nonskid material may be configured to cover the entire work area 16. In an alternate embodiment of the present invention, the nonskid material may be positioned as a plurality of strips on the bottom surface of the food preparation station. In addition, it is preferred that the nonskid material be affixed directly on the bottom surface, although in alternate embodiments, the nonskid material may be separate from the food preparation station. The nonskid material may be constructed of any material, such as silicon strips or a rubberized material, such as used in shelf liners. The nonskid material prevents the food preparation station from sliding on top of the counter top.

FIG. 3 is an enlarged partial side view of the utensil retaining area 12 in the preferred embodiment of the present invention. The utensil retaining area preferably includes a depression 40 created by deforming an end portion of the food preparation station adjacent the back splash when positioned on the counter top 20. As illustrated, the depression is obtaining by initially bending the food preparation upwardly and then bending the edge downwardly in a series of angular displacements. In the preferred embodiment of the present invention, the depression is sized and shaped to accommodate a wood dowel French rolling pin 42. However, the depression may be any shape and size to accommodate and retain any kitchen utensil, such as a knife or a large spoon.

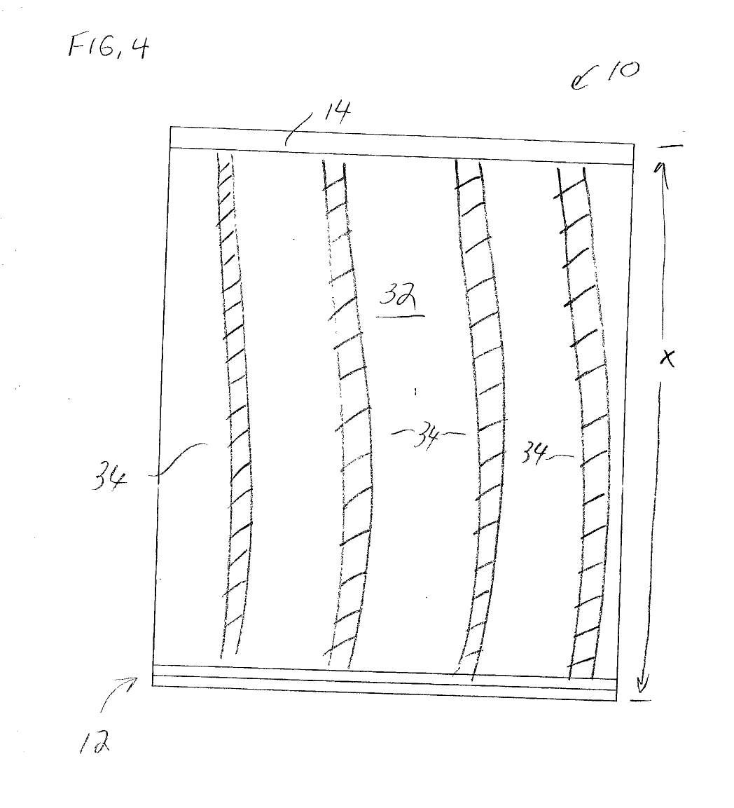

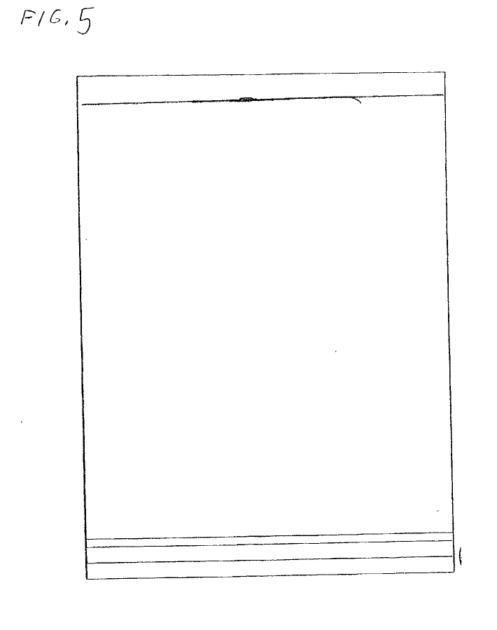

FIG. 4 is a bottom view of the food preparation station 10 in a first alternate embodiment of the present invention. The food preparation station may include a plurality of strips constructed of the nonskid material 34.

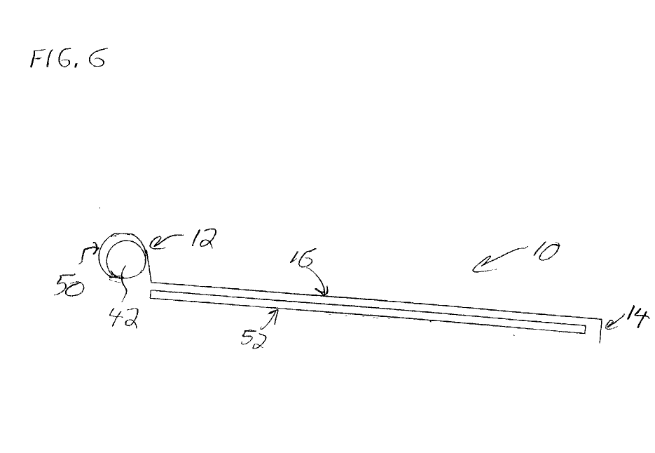

FIG. 5 is atop plan view of the food preparation station 10 in a second alternate embodiment of the present invention. FIG. 6 is an enlarged partial side view of the retaining area 12 of FIG. 5. In this alternate embodiment, the retaining area may include a circularly configured edging 50 large enough and shaped to hold a rolling pin within an interior portion of the curved edging. Additionally, FIG. 6 illustrates an optional nonskid mat 52 (preferably constructed of a silicon padding) which may be affixed or remain separate from the food preparation station. As with the nonskid material 34, the nonskid mat may be utilized to prevent skidding of the food preparation station on the counter top.

With reference to FIGS. 1-6, the operation of the food preparation station will now be explained. The food preparation station may be stored in a convenient, yet unobtrusive place. When desired for use, the food preparation station is positioned on a counter top. The utensil retaining area 12 is laid adjacent and abutted against the back splash 24 or back wall 26. The anchoring ledge is positioned along the edge 22 of the counter top. The work area 16 is used as an area for the preparation of food. For example, an individual may chop, cut or otherwise prepare food without damaging the underlying counter top. In addition, with a stainless steel construction, the work area may be used to roll or knead dough, without sticking to the work area. A cooking utensil, such as the rolling pin 42 may be conveniently located within the utensil retaining area 12. This retaining area provides easy access of the cooking utensil by an individual utilizing the food preparation station. Once the food preparation station is no longer needed, the food preparation station may be easily washed. Since the surface is constructed of a rigid material, preferably stainless steel, a thorough cleaning of the food preparation station may be easily accomplished. Once cleaned, the food preparation station may be stored in a storage area or remain on the counter top for future use.

Although the food preparation station 10 may include the utensil retaining area 12, in alternate embodiments of the present invention, the utensil retaining area may be removed or positioned on the side or forward edge of the food preparation station. In addition, although stainless steel is preferred, any rigid material may be used, such as a hard plastic.

The present invention provides several advantages over existing food preparation areas. First, the food preparation station 10 provides a clean surface which may be easily and thoroughly cleaned to remove all bacteria and dirt. In addition, the food preparation station is constructed of a material which may withstand sharp objects, such as knives. The food preparation station is configured to prevent the preparation station from slipping on the counter top, thus providing a firm and stable platform. The food preparation station also includes a convenient retaining mechanism for holding a kitchen utensil close by the operator. The food preparation station is mobile and can be easily stored when not in use.

It is thus believed that the operation and construction of the present invention will be apparent from the foregoing description. While the device shown and described has been characterized as being preferred, it will be readily apparent that various changes and modifications could be made therein without departing from the scope of the invention as defined in the following claims.

What is claimed is:

1. A food preparation station for use on a counter top, said food preparation station comprising:
a flat work surface having a front edge and a back edge;
the front edge having an anchoring ledge laying against a front counter edge of the counter top;
the back edge abutted against a back wall running perpendicular to the counter top;
a nonskid material positioned between a bottom surface of said flat work surface and a top surface of the counter top for preventing slippage of the food preparation station on the counter top;
whereby the food preparation station is laid on the counter top and is positioned against the back wall and anchored along the anchoring ledge.

2. The food preparation station of claim 1 further comprising a retaining means for holding a cooking utensil, the retaining means being sized and shaped to hold the cooking utensil and affixed to the food preparation station.

3. The food preparation station of claim 2 wherein the retaining means includes a depression for positioning the cooking utensil therein.

4. The food preparation station of claim 3 wherein the cooking utensil is a rolling pin.

5. The food preparation station of claim 2 wherein the retaining means includes the back edge is curved into a generally circular shape creating an area for retaining the cooking utensil.

6. The food preparation station of claim 5 wherein the cooking utensil is a rolling pin.

7. The food preparation station of claim 1 wherein the nonskid material includes a plurality of strips affixed to the bottom surface.

8. The food preparation station of claim 1 wherein the nonskid material is constructed of a silicon pad.

9. The food preparation station of claim 1 wherein the nonskid material is constructed of a rubberized material.

10. The food preparation station of claim 1 wherein the nonskid material is a pad sized to cover the flat surface.

11. The food preparation station of claim 1 wherein the flat work surface is constructed of stainless steel.

12. A food preparation system, said food preparation system comprising:
a counter adjacent a back wall, said counter having a front counter edge;
a food preparation station having a planar work area with a front portion and a rear portion;
the front portion having an anchoring ledge laying against the front counter edge;
the back portion being abutted against the back wall;
a nonskid material positioned between a bottom surface of the planar work area and a top surface of the counter for preventing slippage of the food preparation station on the counter;
whereby the food preparation station is laid on the counter and is positioned against the back wall and anchored along the anchoring ledge.

13. The food preparation system of claim 12 further comprising a retaining means for holding a cooking utensil, the retaining means being sized and shaped to hold the cooking utensil and affixed to the food preparation station.

14. The food preparation system of claim 12 wherein the food preparation station is constructed of stainless steel.

15. A food preparation station for use on a counter top, said food preparation station comprising:
a flat work surface having a front edge and a back edge;
said front edge having an anchoring ledge laying against a front counter edge of the counter top;
the back edge abutted against a back wall running perpendicular to the counter top;
a nonskid material positioned between a bottom surface of said flat work surface and a top surface of the counter top for preventing slippage of the food preparation station on the counter top; and
a retaining means for holding a cooking utensil, the retaining means being sized and shaped to hold the cooking utensil and affixed to the food preparation station;
whereby the food preparation station is positioned on the counter top and is held in position against the back wall and anchored along the anchoring ledge.

16. The food preparation station of claim 15 wherein the preparation station is constructed of stainless steel.
